(19) United States
(12) Patent Application Publication
(10) Pub. No.: US 2025/0253496 A1
(43) Pub. Date: Aug. 7, 2025

(54) FUEL CELL FLUIDIC AND ELECTRICAL QUICK CONNECT SYSTEM

(71) Applicant: GM Global Technology Operations LLC, Detroit, MI (US)

(72) Inventors: Martin Heinzmann, Rochester Hills, MI (US); Hans Peter Ahlborn, Pontiac, MI (US)

(73) Assignee: GM Global Technology Operations LLC, Detroit, MI (US)

(21) Appl. No.: 18/434,138

(22) Filed: Feb. 6, 2024

(51) Int. Cl. H01M 50/509; H01M 50/517

(52) U.S. Cl. CPC H01M 50/509; H01M 50/517; H01M 2250/20

(57) ABSTRACT

A fuel cell system for an application includes a fuel cell module having a cell-side attachment plate. The cell-side attachment plate includes a plurality of connectors and is configured to interface with an application-side attachment plate at the application to align the plurality of connectors of the cell-side attachment plate with a corresponding plurality of connectors of the application-side attachment plate. A fastening mechanism is selectively movable between a locked state, where the cell-side attachment plate is retained at the application-side attachment plate and the plurality of connectors of the cell-side attachment plate and the plurality of connectors of the application-side attachment plate are connected, and an unlocked state, where the plurality of connectors of the cell-side attachment plate and the plurality of connectors of the application-side attachment are disconnected and the fuel cell module is movable relative to the application-side attachment plate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to connecting and installing a fuel cell module to an application and disconnecting and removing a fuel cell module from an application, such as a vehicle. Installation of a fuel cell module requires the attachment of various electrical wires and fluidic hoses between the fuel cell module and systems at the vehicle to allow the fuel cell module to supply the application with fuel. For example, connections are generally plumbed from components, systems, or circuits of the fuel cell module, such as a fuel cell stack, a compressor, and power electronics, among others, to the corresponding components, systems, or circuits at the vehicle, such as a radiator, a surge tank, and a hydrogen storage vessel, among others. Because these connections are typically formed via individual connectors that require separate attachment and detachment and that are disposed at various locations about the fuel cell and vehicle, installation and removal of the fuel cell module at the vehicle is a time-consuming process.

Further, to avoid introduction of air and/or debris into the fluidic circuits and to avoid spillage of fluid from the fuel cell module or vehicle during installation and removal, the fluidic circuits of the fuel cell module are typically drained before removal of the fuel cell module from the vehicle and filled after the fuel cell module is installed into the vehicle. Combined with the amount of time required to independently connect and disconnect the systems of the fuel cell module and vehicle during the installation and removal of the fuel cell module, draining and filling the fuel cell module with fluid while the fuel cell module is installed at the vehicle results in the vehicle being out of commission for an extended amount of time while these procedures are performed.

### SUMMARY

One aspect of the disclosure provides a fuel cell system for an application. The fuel cell system includes a fuel cell module having a cell-side attachment plate. The cell-side attachment plate includes a plurality of connectors and is configured to selectively interface with an application-side attachment plate at the application to align the plurality of connectors of the cell-side attachment plate with a corresponding plurality of connectors of the application-side attachment plate. The fuel cell system also includes a fastening mechanism selectively movable between a locked state and an unlocked state. In the locked state, the cell-side attachment plate is retained at the application-side attachment plate and the plurality of connectors of the cell-side attachment plate and the plurality of connectors of the application-side attachment plate are connected. In the unlocked state, the plurality of connectors of the cell-side attachment plate and the plurality of connectors of the application-side attachment are disconnected and the fuel cell module is movable relative to the application-side attachment plate.

Implementations of the disclosure may include one or more of the following optional features. In some examples, the plurality of connectors at the cell-side attachment plate are arranged relative to a planar surface of the cell-side attachment plate. The planar surface of the cell-side attachment plate is configured to interface with a corresponding planar surface of the application-side attachment plate.

In some implementations, at least one connector of the plurality of connectors at the cell-side attachment plate and at least one corresponding connector of the plurality of connectors at the application-side attachment plate include electrical connectors.

In some aspects, at least one connector of the plurality of connectors at the cell-side attachment plate and at least one corresponding connector of the plurality of connectors at the application-side attachment plate include fluid connectors. In further aspects, at least one fluid connector at the cell-side attachment plate and at least one corresponding fluid connector at the application-side attachment plate include dry-break connectors. In some further aspects, the fuel cell module is prefilled prior to installation at the application, and at least one dry-break connector at the cell-side attachment plate retains fluid within the fuel cell module prior to installation at the application. In other further aspects, at least one fluid connector at the cell-side attachment plate and at least one corresponding fluid connector at the application-side attachment plate fluidly connect a cooling circuit extending between the fuel cell module and the application when the plurality of connectors at the cell-side attachment plate are connected to the corresponding plurality of connectors at the application-side attachment plate.

In some examples, the fuel cell module is axially movable relative to the application-side attachment plate along a predetermined path of motion to axially align the plurality of connectors at the cell-side attachment plate with the corresponding plurality of connectors at the application-side attachment plate when the fastening mechanism in the unlocked state.

In some implementations, the fuel cell module is supported along a support structure that limits movement of the fuel cell module along the predetermined path of motion when the fuel cell module is installed at the application.

In some aspects, each connection between the plurality of connectors at the cell-side attachment plate and the plurality of connectors at the application-side attachment plate is disconnected via a single input when the fastening mechanism is adjusted from the locked state to the unlocked state. In some examples, the application includes a vehicle.

Another aspect of the disclosure provides a vehicle. The vehicle includes a fuel cell system. The fuel cell system includes a fuel cell module having a cell-side attachment plate including a plurality of connectors. The cell-side attachment plate is configured to selectively interface with a vehicle-side attachment plate at the vehicle to align the plurality of connectors of the cell-side attachment plate with a corresponding plurality of connectors of the vehicle-side attachment plate. The fuel cell system also includes a fastening mechanism selectively movable between a locked state and an unlocked state. In the locked state, the cell-side attachment plate is retained at the vehicle-side attachment plate and the plurality of connectors of the cell-side attachment plate and the plurality of connectors of the vehicle-side attachment plate are connected. In the unlocked state, the plurality of connectors of the cell-side attachment plate and the plurality of connectors of the vehicle-side attachment are disconnected and the fuel cell module is movable relative to the vehicle-side attachment plate.

Implementations of this aspect of the disclosure may include one or more of the following optional features. In some examples, the plurality of connectors at the vehicle-side attachment plate are arranged relative to a planar surface of the cell-side attachment plate. The planar surface of the cell-side attachment plate is configured to interface with a corresponding planar surface of the vehicle-side attachment plate.

In some implementations, at least one connector of the plurality of connectors at the cell-side attachment plate and at least one corresponding connector of the plurality of connectors at the vehicle-side attachment plate include electrical connectors.

In some aspects, at least one connector of the plurality of connectors at the cell-side attachment plate and at least one corresponding connector of the plurality of connectors at the vehicle-side attachment plate include fluid connectors. At least one fluid connector at the cell-side attachment plate and at least one corresponding fluid connector at the vehicle-side attachment plate include dry-break connectors.

In some examples, each connection between the plurality of connectors at the cell-side attachment plate and the plurality of connectors at the vehicle-side attachment plate is disconnected via a single input when the fastening mechanism is adjusted from the locked state to the unlocked state.

Yet another aspect of the disclosure provides a method. The method includes installing a fuel cell module of a fuel cell system at an application, the fuel cell module having a cell-side attachment plate including a plurality of connectors, the cell-side attachment plate configured to selectively interface with an application-side attachment plate at the application to align the plurality of connectors of the cell-side attachment plate with a corresponding plurality of connectors of the application-side attachment plate. The method also includes, with the fuel cell module installed at the application, adjusting a fastening mechanism selectively movable from an unlocked state, where the plurality of connectors of the cell-side attachment plate and the plurality of connectors of the application-side attachment are disconnected and the fuel cell module is movable relative to the application-side attachment plate, to a locked state, where the cell-side attachment plate is retained at the application-side attachment plate and the plurality of connectors of the cell-side attachment plate and the plurality of connectors of the application-side attachment plate are connected.

Implementations of this aspect of the disclosure may include one or more of the following optional features. In some examples, the method further includes adjusting the fastening mechanism from the locked state to the unlocked state via a single input, disconnecting each connection between the plurality of connectors at the cell-side attachment plate and the plurality of connectors at the application-side attachment plate.

In some implementations, the fuel cell module is axially movable relative to the application-side attachment plate along a predetermined path of motion to axially align the plurality of connectors at the cell-side attachment plate with the corresponding plurality of connectors at the application-side attachment plate when the fastening mechanism in the unlocked state. In some aspects, the fuel cell module is prefilled prior to installation at the application.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic diagram of a fuel cell module and a vehicle with corresponding connection points along respective attachment plates of the fuel cell module and vehicle.

FIGS. 2 and 3 are perspective views of the attachment plate at the vehicle and the attachment plate at the fuel cell module.

FIG. 4 is a perspective view of the attachment plate at the fuel cell module.

FIG. 5 is a flowchart of an example method of installing the fuel cell module into the vehicle.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

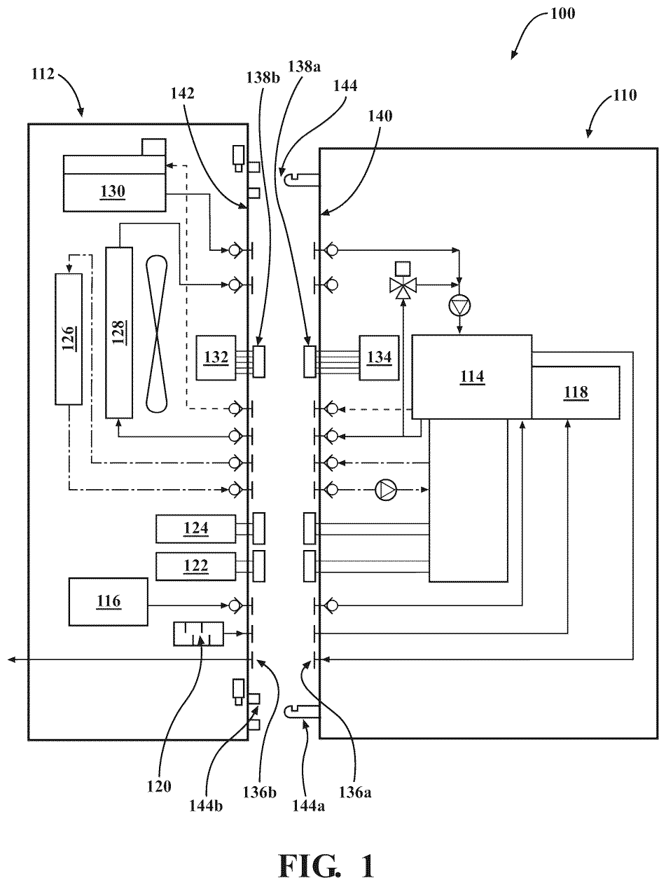

With reference to FIG. 1, a fuel cell system 100 includes a fuel cell module 110, such as a hydrogen-powered fuel cell, configured for installation at and removal from a vehicle 112. Although described herein as relating to a fuel cell module 110 suitable for installation at and removal from a vehicle 112, it should be understood that the fuel cell module 110 may be installed at and removed from any suitable application, such as a personal vehicle, a public transportation vehicle, a marine vessel, construction equipment, an aircraft, a spacecraft, and the like.

When the fuel cell module 110 is installed at the vehicle 112, a plurality of electrical connections and a plurality of fluidic connections are formed between the fuel cell module 110 and the vehicle 112, such as to transfer electrical power generated at the fuel cell module 110 to the vehicle 112 and to circulate coolant through radiators at the vehicle 112 for regulating temperature at the fuel cell module 110. For example, the fuel cell module 110 includes a fuel cell stack 114 that receives a fuel, such as hydrogen, from a fuel storage 116 at the vehicle 112. The fuel cell stack 114 receives air flow from a compressor 118 at the fuel cell module 110 that draws air intake from an air filter 120 at the vehicle 112. High voltage (HV) power generated at the fuel cell stack 114 is transferred to the vehicle 112, while the vehicle 112 may supply low voltage (LV) power to the fuel cell module 110. A low voltage system 122 and/or a high voltage system 124 accommodates the transfer of power between the fuel cell module 110 and the vehicle 112. Exhaust from the fuel cell stack 114 may be fed through an exhaust system at the vehicle 112. Coolant may be circulated between the vehicle 112 and the fuel cell module 110 to regulate the temperature of various components within the vehicle 112 and the fuel cell module 110. Low temperature (LT) coolant is exchanged between a LT radiator 126 at the vehicle 112 and the fuel cell module 110, where the LT coolant generally cools the compressor 118 and other power electronics. High temperature (HT) coolant is exchanged between a HT radiator 128 at the vehicle 112 and the fuel cell module 110, where the HT coolant generally cools the fuel cell stack 114. A surge tank 130 at the vehicle 112 may be in fluid communication with the fuel cell module 110, to receive degas from the fuel cell stack 114. An electrical connection is established between a control module 132 at the vehicle 112 and a control module 134 at the fuel cell module 110, to transmit control signals and diagnostic information between the fuel cell module 110 and the vehicle 112.

To facilitate formation of the plurality of fluidic connections and the plurality of electrical connections between the fuel cell module 110 and the vehicle 112, a plurality of first or cell-side fluidic connectors 136a and a plurality of first or cell-side electrical connectors 138a are provided at a first or cell-side attachment plate 140 of the fuel cell module 110 and a corresponding plurality of second or application-side or vehicle-side fluidic connectors 136b and a plurality of second or application-side or vehicle-side electrical connectors 138b are provided at a second or application-side or vehicle-side attachment plate 142 of the vehicle 112. Each of the cell-side fluidic connectors 136a corresponds to a respective vehicle-side fluidic connector 136b and each of the cell-side electrical connectors 138a corresponds to a respective vehicle-side electrical connector 138b such that connection of the respective connectors enables unencumbered interaction between the fuel cell module 110 and the vehicle 112. As discussed further below, the cell-side attachment plate 140 and the vehicle-side attachment plate 142 each comprises a planar surface with each cell-side fluidic connector 136a and cell-side electric connector 138a arranged at a position along the cell-side attachment plate 140 that aligns with the position of a corresponding vehicle-side fluidic connector 136b or vehicle-side electric connector 138b on the vehicle-side attachment plate 142. Thus, when the planar cell-side attachment plate 140 interfaces with the planar vehicle-side attachment plate 142, each cell-side connector is aligned with and connected to a corresponding vehicle-side connector.

With continued reference to FIG. 1, a fastening mechanism 144 assists in alignment between the connectors at the cell-side attachment plate 140 and the vehicle-side attachment plate 142 when the cell-side attachment plate 140 interfaces with the vehicle-side attachment plate 142. For example, the fastening mechanism 144 includes a first portion or locking portion 144a that extends from the cell-side attachment plate 140 and a second portion or receiving portion 144b at the vehicle-side attachment plate 142. In some examples, the locking portion 144a is disposed at the vehicle-side attachment plate 142 and the receiving portion 144b is disposed at the cell-side attachment plate 140. The fastening mechanism 144 is adjustable between a locked or engaged state and an unlocked or disengaged state. In the locked or engaged state, the first portion 144a engages the second portion 144b and the cell-side attachment plate 140 is retained at the vehicle-side attachment plate 142 and the plurality of connectors 136a, 138a at the cell-side attachment plate 140 and the plurality of connectors 136b, 138b at the vehicle-side attachment plate 142 are connected. In the unlocked or disengaged state, the first portion 144a releases the second portion 144b and the plurality of connectors 136a, 138a at the cell-side attachment plate 140 and the plurality of connectors 136b, 138b at the vehicle-side attachment plate 142 are disconnected and the fuel cell module 110 is movable relative to the vehicle-side attachment plate 142. As described further below, with the fastening mechanism 144 in the unlocked state, the fuel cell module 110 is removable from the vehicle 112, such as for performing maintenance on the fuel cell module 110 and/or replacement of the fuel cell module 110 at the vehicle 112. Aligning the plurality of connectors 136a, 136b, 138a, 138b between the fuel cell module 110 and the vehicle 112 and adjusting the fastening mechanism 144 from the unlocked state to the locked state connects the plurality connectors 136a, 136b, 138a, 138b and retains the fuel cell module 110 at the vehicle 112. The fastening mechanism 144 may be of any style or variety that facilitates a locked state and an unlocked state, where adjustment of the fastening mechanism 144 from the locked state to the unlocked state, and vice versa, may be achieved automatically, such as with a spring-operated clip, ball lock, or similar device, or may be achieved manually, such as with a nut and bolt, or similar device, that must be attached by a technician.

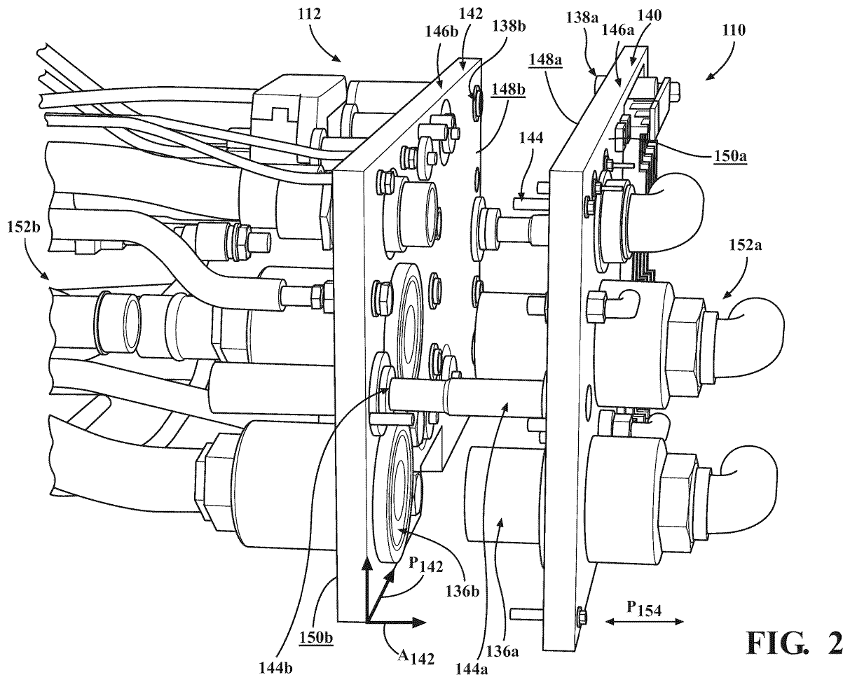

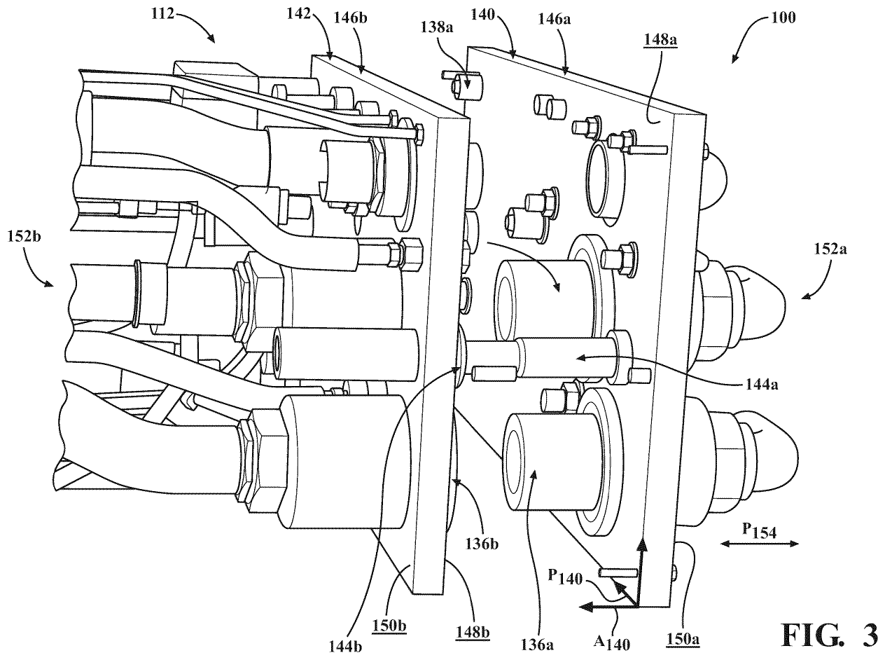

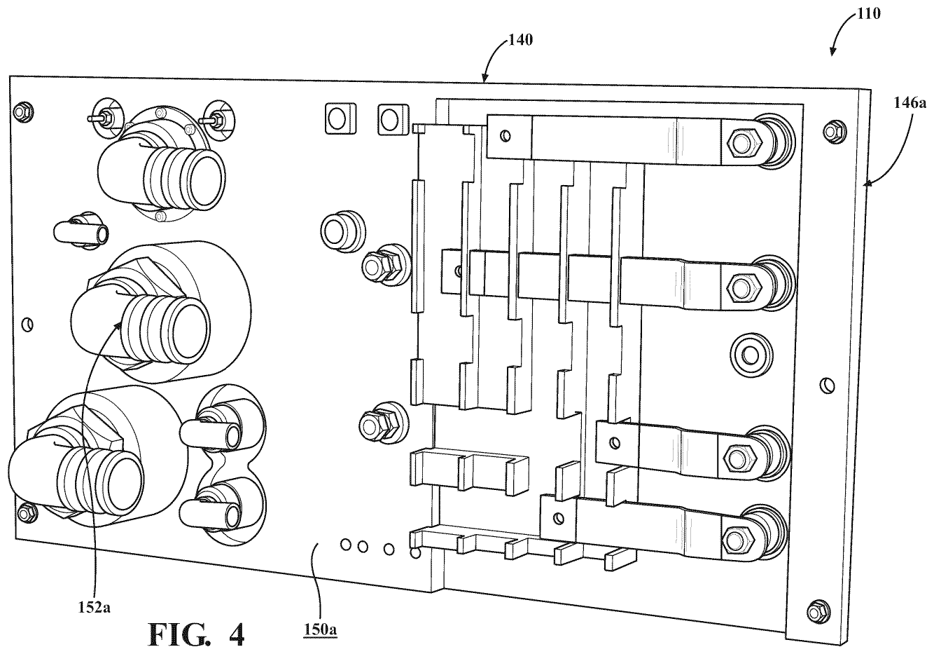

With reference now to FIGS. 2-4, the cell-side attachment plate 140 includes a body or plate 146a having a first or exterior side 148a, defining a surface, and a second or interior side 150a, defining a surface, opposite the exterior side 148a and the vehicle-side attachment plate 142 include a body 146b having a first or exterior side 148b, defining a surface, and a second or interior side 150b, defining a surface, opposite the exterior side 148b. As shown, the systems and components at the fuel cell module 110 are plumbed to the connectors 136a, 138a at the exterior side 148a of the cell-side attachment plate 140 via a connection system 152a, such as an array of hoses and wiring that extend between the interior side 150a of the cell-side attachment plate 140 and the respective systems and components of the fuel cell module 110. Similarly, the systems and components of the vehicle 112 are plumbed to the plurality of connectors 136b, 138b at the exterior side 148b of the vehicle-side attachment plate 142 via a connection system 152b, such as an array of hoses and wiring that extend between the interior side 150b of the vehicle-side attachment plate 142 and the respective systems and components of the vehicle 112. The hoses and wiring of the fuel cell module 110 connect to the individual fluidic connectors 136a and electric connectors 138a that are located on the exterior side 148a of the cell-side attachment plate 140, and the hoses and wiring of the vehicle 112 connect to the individual fluidic connectors 136b and electric connectors 138b that are located on the exterior side 148b of the vehicle-side attachment plate 142. The layout, positioning, and/or quantity of the fluidic connectors 136a, 136b and electric connectors 138a, 138b at the cell-side attachment plate 140 and the vehicle-side attachment plate 142, as well as the corresponding hoses and wiring, may be adjusted as needed to suit the configuration of the fuel cell module 110 and vehicle 112.

With continued reference to FIGS. 2-4, at least one fluidic connector 136a at the cell-side attachment plate 140 and at least one corresponding fluidic connectors 136b at the vehicle-side attachment plate 142 includes a dry-break style connector. That is, the dry-break connectors enable fluid communication between the fuel cell module 110 and the vehicle 112 when the fuel cell module 110 is fully connected to the vehicle 112 and preclude fluid communication at the respective connector when the fuel cell module 110 and the vehicle 112 are disconnected. Accordingly, the dry-break connectors accommodate spill-free disconnection of the fuel cell module 110 and the vehicle 112 and allow for filling of the fuel cell module 110 and/or vehicle 112 with fluid prior to connection between the fuel cell module 110 and vehicle 112 without losing fluid prior to connection. Put another way, when the dry-break connector at the fuel cell module 110 or vehicle 112 is connected to a fluid source or the other of the fuel cell module 110 and vehicle 112, the dry-break connector allows for fluid exchange into and out of the fuel cell module 110 or vehicle 112 and, when the dry-break connector is disconnected from the fluid source or the other of the fuel cell module 110 or vehicle 112, the dry-break connector may instantaneously seal itself, preventing fluid from leaking out of the dry-break connector and retaining the fluid in the fuel cell module 110 and vehicle 112. The cell-side attachment plate 140 may include fluidic connectors 136a that are dry-break connectors and fluidic connectors 136a that are not dry-break connectors, and the vehicle-side attachment plate 142 may include fluidic connectors 136b that are dry-break connectors and fluidic connectors 136b that are not dry-break connectors.

For every fluidic connector 136a present on the cell-side attachment plate 140, a corresponding fluidic connector 136b is present on the vehicle-side attachment plate 142. The corresponding fluidic connectors 136a, 136b are aligned and able to interact and connect with one another when the fuel cell module 110 is installed at the vehicle 112. Similarly, for every electric connector 138a present on the cell-side attachment plate 140, a corresponding electric connector 138b is present on the vehicle-side attachment plate 142. The connectors 138a, 138b are aligned and able to interact and connect with one another when the fuel cell module 110 is installed at the vehicle 112.

With the fuel cell module 110 disconnected from the vehicle 112, the fluidic circuits of the fuel cell module 110 and/or the vehicle 112 may be pre-filled with fluid via the dry-break fluidic connectors 136a 136b. Because the fluidic connectors 136a include dry-break connectors, filling the fuel cell module 110 with fluid may be accomplished remotely from the vehicle 112 with the dry-break connector retaining the fluid within the fuel cell module 110 prior to installation at the vehicle 112. For example, the fuel cell module 110 may include a fluidic cooling circuit that connects with the cooling system of the vehicle 112 and a dry-break connector allows coolant to be pumped into the fuel cell module 110 and/or vehicle 112 prior to installation of the fuel cell module 110 at the vehicle 112. Additionally, while hydrogen or other fuel may not necessarily be pre-filled into the fuel cell module 110 but, rather, filled during recommissioning of the fuel cell module 110 at the vehicle 112, the use of dry-break fluidic connectors 136a, 136b reduces the possibility of debris entering the fuel cell module 110 and/or vehicle 112. As the circuit supplying fuel between the fuel cell module 110 and the vehicle 112 is generally sensitive to debris and other contaminants, reducing the possibility of debris entering the circuit reduces risk of damage to the fuel cell module 110 and the vehicle 112.

Pre-filling the fuel cell module 110 via the dry break fluidic connectors 14a allows for a time-consuming purging or degassing process to take place with the fuel cell module 110 removed from the vehicle 112. Such a process may be required in conjunction with the filling of fluid into the fuel cell module 110 to remove air and other gases from the fluidic circuits. Accordingly, the filling and purging process of the fuel cell module 110 may be performed before the fuel cell module 110 is installed in the vehicle 112, freeing up the vehicle 112 for other services, or allowing for installation of a secondary fuel cell module while the original fuel cell module 110 is being filled with fluid and purged, allowing the vehicle 112 to be recommissioned following a more efficient process. Additionally, use of dry-break style fluidic connectors 136a may reduce fluid spillage during installation and removal of the fuel cell module 110 at the vehicle, reducing danger to technicians, reducing risk of environmental hazards, and reducing fluid waste. Connectors that are of the dry-break style prevent the risk of spilling fluid due to its design of simultaneously sealing the circuit once the filling apparatus is removed from the connector. Furthermore, the pre-filling process of the fuel cell module 110 remotely from the vehicle 112 will provide easier access for a technician to perform the pre-filling process, as the fuel cell module 110 is not required to be within the sometimes tight and cumbersome confines of the vehicle 112. The fluidic connectors 136a, 136b being of the dry-break style will also reduce the potential for debris to enter the fluidic circuits, as the fluidic connectors 136a, 136b remain sealed when the fuel cell module 110 is not connected and attached to the vehicle 112. Further, it may not be necessary to drain fluid from either the fuel cell module 110 or the vehicle 112 before removal of the fuel cell module 110 from the vehicle 112, as the fluid will be retained within the fuel cell module 110 and the vehicle 112 via the dry-break connectors, resulting in more efficient removal of the fuel cell module 110 from the vehicle 112.

To install the fuel cell module 110 into the vehicle 112, such as after the fuel cell module 110 is pre-filled with fluid, the cell-side attachment plate 140 may be axially aligned with the vehicle-side attachment plate 142. In other words, an axis A140 extending perpendicular to a plane P140 of the exterior side 148a of the cell-side attachment plate 140 is aligned with an axis A142 extending perpendicular to a plane P142 of the exterior side 148b of the vehicle-side attachment plate 142 so that the fluidic connectors 136a, the electric connectors 138a, and the fastening mechanism 144 on the cell-side attachment plate 140 are aligned with the corresponding fluidic connectors 136b, the corresponding electric connectors 138b, and the corresponding portion 144b of the fastening mechanism 144 on the vehicle-side attachment plate 142. With the fastening mechanism 144 in the unlocked state, the fuel cell module 110 is axially movable (i.e., along the axis A140) relative to the vehicle-side attachment plate 142 to interface the cell-side attachment plate 140 and the vehicle-side attachment plate 142 and connect the corresponding connectors 136a, 136b, 138a, 138b. For example, to facilitate the proper alignment, the fuel cell module 110 may be disposed along a track, a rail, or a similar apparatus that facilitates the axial movement of the fuel cell module 110 relative to the vehicle-side attachment plate 142 along a predefined linear path P154 parallel to the axes A140, A142, where the support structure supports the fuel cell module 110 and limits movement of the fuel cell module 110 away from the predefined path of motion P154. The predefined path of motion P154 axially aligns the connectors 136a, 138a at the cell-side attachment plate 140 and the plurality of connectors 136b, 138b at the vehicle-side attachment plate 142 and brings the fastening mechanism 144 into engagement, where the fastening mechanism 144 may be adjusted from the unlocked state to the locked state once the fuel cell module 110 is fully installed and the cell-side attachment plate 140 interfaces with the vehicle-side attachment plate 142.

Adjustment of the fastening mechanism 144 between the unlocked state and the locked state may be achieved automatically as the cell-side attachment plate 140 interfaces with and engages the vehicle-side attachment plate 142. For example, the fastening mechanism 144 may include a spring operated clip, a ball lock, and the like. Optionally, adjustment of the fastening mechanism 144 between the locked state and the unlocked state may be achieved manually. For example, the fastening mechanism 144 may include a nut and bolt, or similar device, that is adjusted and attached once the fuel cell module 110 is fully installed in the vehicle 112.

Because the plurality of connectors 136a, 138a at the cell-side attachment plate 140 are arranged relative to the planar exterior side 148a of the cell-side attachment plate 140, and the plurality of connectors 136b, 138b at the vehicle-side attachment plate 142 are arranged relative to the planar exterior side 148b of the vehicle-side attachment plate 142, engagement of the cell-side attachment plate 140 with the vehicle-side attachment plate 142 results in connection of each of the fluidic connectors 136a and the electric connectors 138a on the cell-side attachment plate 140 to the corresponding fluidic connectors 136b and the corresponding electric connectors 138b on the vehicle-side attachment plate 142. Adjustment of the fastening mechanism 144 between the locked state and the unlocked state allows for each connection between the fluidic connectors 136a and the electric connectors 138a on the cell-side attachment plate 140 to the corresponding fluidic connectors 136b and the corresponding electric connectors 138b on the vehicle-side attachment plate 142 to be connected and disconnected via a single input (e.g., engagement between the attachment plates and/or a manual input to connect the fuel cell module 110 and the vehicle 112).

During removal of the fuel cell module 110 from the vehicle 112, the fastening mechanism 144, may be unlocked, either automatically or manually, at which point, a single motion of axially moving the fuel cell module 110 away from the vehicle-side attachment plate 142 along the linear path P154 renders the fuel cell module uninstalled. The fluidic connectors 136a and the electric connectors 138a on the cell-side attachment plate 140 will be disconnected from the corresponding fluidic connectors 136b and the corresponding electric connectors 138b on the vehicle-side attachment plate 142. Due to the dry-break style of the fluidic connectors 136a, 136b, the removal of the fuel cell module 110 precludes the leaking of fluid, and no prior draining of fluid is necessary. The fluid will be retained in both the fuel cell module 110 and the vehicle 112.

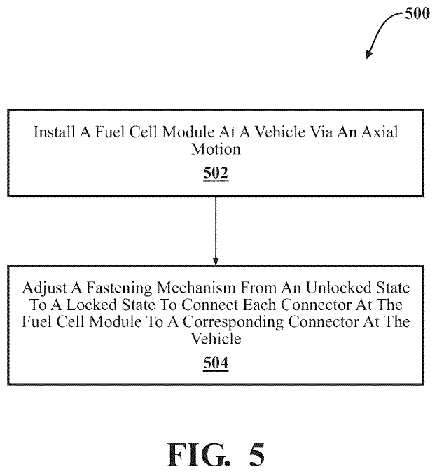

FIG. 5 provides a flowchart of an exemplary arrangement of operations for a method 500 of installing the fuel cell module 110 of the fuel cell system 100 at the vehicle 112. At operation 502, the method 500 includes installing the fuel cell module 110 at the vehicle 112 so that the cell-side attachment plate 140 of the fuel cell module 110 interfaces with the vehicle-side attachment plate 142 at the vehicle 112 and the plurality of connectors 136a, 138a, at the cell-side attachment plate 140 are aligned with the corresponding plurality of connectors 136b, 138b at the vehicle-side attachment plate 142. The fuel cell module 110 may be prefilled prior to installation at the vehicle 112. With the fastening mechanism 144 in an unlocked state, the fuel cell module 110 may be axially movable relative to the vehicle-side attachment plate 142 along a predetermined path of motion P154 that axially aligns the plurality of connectors 136a, 138a at the cell-side attachment plate 140 with the corresponding plurality of connectors 136b, 138b at the vehicle-side attachment plate 142. At operation 504, the method 500 includes, with the fuel cell module 110 installed at the vehicle 112, adjusting a fastening mechanism 144 from an unlocked state, where the plurality of connectors 136a, 138a at the cell-side attachment plate 140 and the plurality of connectors 136b, 138b at the vehicle-side attachment plate 142 are disconnected and the fuel cell module 110 is movable relative to the vehicle-side attachment plate 142, to a locked state, where the cell-side attachment plate 140 is retained at the vehicle-side attachment plate 142 and the plurality of connectors 136a, 138a at the cell-side attachment plate 140 and the plurality of connectors 136a, 136b at the vehicle-side attachment plate 142 are connected. In some examples, the method 500 further includes adjusting the fastening mechanism from the locked state to the unlocked state, wherein adjusting the fastening mechanism 144 from the locked state to the unlocked state allows each connection between the plurality of connectors 136a, 138a at the cell-side attachment plate 140 and the plurality of connectors 136b, 138b at the vehicle-side attachment plate 142 to be disconnected via a single input.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A fuel cell system for an application, the fuel cell system comprising:
a fuel cell module having a cell-side attachment plate including a plurality of connectors, the cell-side attachment plate configured to selectively interface with an application-side attachment plate at the application to align the plurality of connectors of the cell-side attachment plate with a corresponding plurality of connectors of the application-side attachment plate; and
a fastening mechanism selectively movable between (i) a locked state, where the cell-side attachment plate is retained at the application-side attachment plate and the plurality of connectors of the cell-side attachment plate and the plurality of connectors of the application-side attachment plate are connected, and (ii) an unlocked state, where the plurality of connectors of the cell-side attachment plate and the plurality of connectors of the application-side attachment are disconnected and the fuel cell module is movable relative to the application-side attachment plate.

2. The fuel cell system of claim 1, wherein the plurality of connectors at the cell-side attachment plate are arranged relative to a planar surface of the cell-side attachment plate, the planar surface of the cell-side attachment plate configured to interface with a corresponding planar surface of the application-side attachment plate.

3. The fuel cell system of claim 1, wherein at least one connector of the plurality of connectors at the cell-side attachment plate and at least one corresponding connector of the plurality of connectors at the application-side attachment plate comprise electrical connectors.

4. The fuel cell system of claim 1, wherein at least one connector of the plurality of connectors at the cell-side attachment plate and at least one corresponding connector of the plurality of connectors at the application-side attachment plate comprise fluid connectors.

5. The fuel cell system of claim 4, wherein at least one fluid connector at the cell-side attachment plate and at least one corresponding fluid connector at the application-side attachment plate comprise dry-break connectors.

6. The fuel cell system of claim 5, wherein the fuel cell module is prefilled prior to installation at the application, at least one dry-break connector at the cell-side attachment plate retaining fluid within the fuel cell module prior to installation at the application.

7. The fuel cell system of claim 4, wherein at least one fluid connector at the cell-side attachment plate and at least one corresponding fluid connector at the application-side attachment plate fluidly connect a cooling circuit extending between the fuel cell module and the application when the plurality of connectors at the cell-side attachment plate are connected to the corresponding plurality of connectors at the application-side attachment plate.

8. The fuel cell system of claim 1, wherein the fuel cell module is axially movable relative to the application-side attachment plate along a predetermined path of motion to axially align the plurality of connectors at the cell-side attachment plate with the corresponding plurality of connectors at the application-side attachment plate when the fastening mechanism in the unlocked state.

9. The fuel cell system of claim 1, wherein the fuel cell module is supported along a support structure that limits movement of the fuel cell module along the predetermined path of motion when the fuel cell module is installed at the application.

10. The fuel cell system of claim 1, wherein each connection between the plurality of connectors at the cell-side attachment plate and the plurality of connectors at the application-side attachment plate is disconnected via a single input when the fastening mechanism is adjusted from the locked state to the unlocked state.

11. The fuel cell system of claim 1, wherein the application comprises a vehicle.

12. A vehicle comprising:
a fuel cell system comprising:
a fuel cell module having a cell-side attachment plate including a plurality of connectors, the cell-side attachment plate configured to selectively interface with a vehicle-side attachment plate at the vehicle to align the plurality of connectors of the cell-side attachment plate with a corresponding plurality of connectors of the vehicle-side attachment plate; and
a fastening mechanism selectively movable between (i) a locked state, where the cell-side attachment plate is retained at the vehicle-side attachment plate and the plurality of connectors of the cell-side attachment plate and the plurality of connectors of the vehicle-side attachment plate are connected, and (ii) an unlocked state, where the plurality of connectors of the cell-side attachment plate and the plurality of connectors of the vehicle-side attachment are disconnected and the fuel cell module is movable relative to the vehicle-side attachment plate.

13. The vehicle of claim 12, wherein the plurality of connectors at the vehicle-side attachment plate are arranged relative to a planar surface of the cell-side attachment plate, the planar surface of the cell-side attachment plate configured to interface with a corresponding planar surface of the vehicle-side attachment plate.

14. The vehicle of claim 12, wherein at least one connector of the plurality of connectors at the cell-side attachment plate and at least one corresponding connector of the plurality of connectors at the vehicle-side attachment plate comprise electrical connectors.

15. The vehicle of claim 12, wherein at least one connector of the plurality of connectors at the cell-side attachment plate and at least one corresponding connector of the plurality of connectors at the vehicle-side attachment plate comprise fluid connectors, at least one fluid connector at the cell-side attachment plate and at least one corresponding fluid connector at the vehicle-side attachment plate comprising dry-break connectors.

16. The vehicle of claim 12, wherein each connection between the plurality of connectors at the cell-side attachment plate and the plurality of connectors at the vehicle-side attachment plate is disconnected via a single input when the fastening mechanism is adjusted from the locked state to the unlocked state.

17. A method comprising:
installing a fuel cell module of a fuel cell system at an application, the fuel cell module having a cell-side attachment plate including a plurality of connectors, the cell-side attachment plate configured to selectively interface with an application-side attachment plate at the application to align the plurality of connectors of the cell-side attachment plate with a corresponding plurality of connectors of the application-side attachment plate; and
with the fuel cell module installed at the application, adjusting a fastening mechanism selectively movable from an unlocked state, where the plurality of connectors of the cell-side attachment plate and the plurality of connectors of the application-side attachment are disconnected and the fuel cell module is movable relative to the application-side attachment plate, to a locked state, where the cell-side attachment plate is retained at the application-side attachment plate and the plurality of connectors of the cell-side attachment plate and the plurality of connectors of the application-side attachment plate are connected.

18. The method of claim 17, wherein the method further comprises adjusting the fastening mechanism from the locked state to the unlocked state via a single input, disconnecting each connection between the plurality of connectors at the cell-side attachment plate and the plurality of connectors at the application-side attachment plate.

19. The method of claim 17, wherein the fuel cell module is axially movable relative to the application-side attachment plate along a predetermined path of motion to axially align the plurality of connectors at the cell-side attachment plate with the corresponding plurality of connectors at the application-side attachment plate when the fastening mechanism in the unlocked state.

20. The method of claim 17, wherein the fuel cell module is prefilled prior to installation at the application.
